(19) United States
(12) Patent Application Publication
(10) Pub. No.: US 2023/0138272 A1
(43) Pub. Date: May 4, 2023

(54) NODE APPARATUS, WDM TRANSMISSION SYSTEM, AND CONTROL METHOD

(71) Applicant: NEC Corporation, Minato-ku, Tokyo (JP)

(72) Inventors: Kazunori SHINYA, Tokyo (JP); Takefumi OGUMA, Tokyo (JP)

(73) Assignee: NEC Corporation, Minato-ku, Tokyo (JP)

(21) Appl. No.: 17/910,285

(22) PCT Filed: Mar. 12, 2021
(86) PCT No.: PCT/JP2021/010032

§ 371 Date: Sep. 8, 2022

(30) Foreign Application Priority Data
Mar. 26, 2020 (JP) 2020-056640

(51) Int. Cl. H04J 14/02

(52) U.S. Cl. CPC H04J 14/0267; H04J 14/0212

(57) ABSTRACT

The present disclosure relates to an NE (90) in a WDM transmission system. The NE (90) according to the present disclosure includes a WSS (901) which allows, in accordance with configurations allocated to a plurality of respective slots, optical signals of the plurality of respective slots to pass, and a WSS control unit (902) which allocates a configuration to each of the plurality of slots. The WSS control unit (902) additionally allocates, if an adjacent slot adjacent to a desired one of the plurality of slots is unused, a configuration for allowing an optical signal to pass through a path the same as that of the desired slot to the adjacent slot.

### TECHNICAL FIELD

The present disclosure relates to a Wavelength Division Multiplexing (WDM) transmission system, a node apparatus in the WDM transmission system, and a control method of a wavelength selective switch in the WDM transmission system.

### BACKGROUND ART

A WDM transmission system achieves high-speed and large-capacity transmission by multiplexing a plurality of optical signals having wavelengths different from each other and transmitting the wavelength-multiplexed signal. In order to achieve a transmission of this kind, each of node apparatuses that form the WDM transmission system is provided with a Wavelength Selective Switch (WSS) including a function of wavelength-demultiplexing a wavelength-multiplexed optical signal that passes through the node apparatus into optical signals having the respective wavelengths and a function of wavelength-multiplexing optical signals having respective wavelengths that pass through the node apparatus (e.g., Patent Literature 1).

### CITATION LIST

### Patent Literature

[Patent Literature 1] Japanese Unexamined Patent Application Publication No. 2012-194471

### SUMMARY OF INVENTION

### Technical Problem

There has recently been a demand to improve the utilization efficiency of a wavelength band in a WDM transmission system. Therefore, narrowing the width of the wavelength band has been discussed. If it is assumed, for example, that 40-channel optical signals can be transmitted when the wavelength band is set to 100 GHz, it becomes possible to transmit 80-channel optical signals by narrowing the wavelength band from 100 GHz to 50 GHz.

In order to narrow the width of the wavelength band from 100 GHz to 50 GHz, each of the node apparatus needs to transmit optical signals, which have been made to pass therethrough in 100 GHz, in 50 GHz. Therefore, it becomes difficult for each of the node apparatuses to cause, in particular, optical signals to pass through it in both a low-frequency side and a high-frequency side of a wavelength band. As a result, waveforms of optical signals that pass through each of the node apparatuses are clipped on the respective sides of the wavelength band, which makes the wavelength band narrow.

Further, in recent years, in the WDM transmission system, there has been a demand to reduce the size of node apparatuses and therefore reduce the size of the WSS. If the size of the WSS is reduced, however, passband characteristics of the WSS are deteriorated, whereby the wavelength band tends to be narrow.

As described above, in the WDM transmission system, due to two causes, namely, narrowing of the wavelength band and reduction in size of the WSS, the wavelength band becomes narrow, resulting in a problem that transmission characteristics are deteriorated.

An object of the present disclosure is to solve the aforementioned problem and to provide a node apparatus, a WDM transmission system, and a control method capable of preventing the wavelength band from becoming narrow and improving transmission characteristics.

### Solution to Problem

A node apparatus according to one aspect is a node apparatus in a Wavelength Division Multiplexing (WDM) transmission system, the node apparatus including:

a wavelength selective switch configured to allow, in accordance with configurations allocated to a plurality of respective slots, optical signals of the plurality of respective slots to pass; and

a control unit configured to allocate the configurations to the plurality of slots, and

in which the control unit additionally allocates, if an adjacent slot adjacent to a desired one of the plurality of slots is unused, the configuration for allowing an optical signal to pass through a path the same as that of the desired slot to the adjacent slot.

A Wavelength Division Multiplexing (WDM) transmission system according to one aspect includes:

a plurality of node apparatuses connected to each other, in which

each of the plurality of node apparatuses includes;
a wavelength selective switch configured to allow, in accordance with configurations allocated to a plurality of respective slots, optical signals of the plurality of respective slots to pass; and
a control unit configured to allocate the configurations to the plurality of slots, and

the control unit additionally allocates, if an adjacent slot adjacent to a desired one of the plurality of slots is unused, the configuration for allowing an optical signal to pass through a path the same as that of the desired slot to the adjacent slot.

A control method according to one aspect is a control method of a wavelength selective switch in a Wavelength Division Multiplexing (WDM) transmission system, in which

the wavelength selective switch allows, in accordance with configurations allocated to a plurality of respective slots, optical signals of the plurality of respective slots to pass,

the control method includes a control step for allocating the configurations to the plurality of slots, and

in the control step, if an adjacent slot adjacent to a desired one of the plurality of slots is unused, the configuration for allowing an optical signal to pass through a path the same as that of the desired slot is additionally allocated to the adjacent slot.

### Advantageous Effects of Invention

According to the aforementioned aspects, it is possible to obtain effects that it is possible to provide a node apparatus, a WDM transmission system, and a control method capable of preventing a wavelength band from becoming narrow and improving transmission characteristics.

### BRIEF DESCRIPTION OF DRAWINGS

FIG. 1 is a diagram showing a network configuration example of a WDM transmission system according to an example embodiment;

FIG. 2 is a diagram showing a network configuration example of the WDM transmission system according to the example embodiment;

FIG. 3 is a block diagram showing a configuration example of a functional block according to optical signal processing of an NE according to the example embodiment;

FIG. 4 is a diagram showing an example of a wavelength demultiplexing function of a WSS according to the example embodiment;

FIG. 5 is a diagram showing an example of a wavelength multiplexing function of the WSS according to the example embodiment;

FIG. 6 is a block diagram showing a configuration example of a functional block according to control by the NE according to the example embodiment;

FIG. 7 is a diagram showing an example of a control method of a WSS according to a related art;

FIG. 8 is a diagram showing an example of a control method of the WSS according to the example embodiment;

FIG. 9 is a diagram showing an example of the control method of the WSS according to the example embodiment;

FIG. 10 is a diagram showing an example of effects of the WDM transmission system according to the example embodiment;

FIG. 11 is a diagram showing an example of effects of the WDM transmission system according to the example embodiment;

FIG. 12 is a diagram showing an example of effects of the WDM transmission system according to the example embodiment; and

FIG. 13 is a block diagram showing a configuration example of the NE that conceptually shows the example embodiment.

### EXAMPLE EMBODIMENT

Hereinafter, with reference to the drawings, an example embodiment of the present disclosure will be described. The following descriptions and the drawings are omitted and simplified as appropriate in order to clarify the explanation. Further, throughout the drawings, the same components are denoted by the same reference symbols and overlapping descriptions will be omitted as appropriate.

### Example Embodiment

Referring first to FIG. 1, a network configuration example of a WDM transmission system according to this example embodiment will be described.

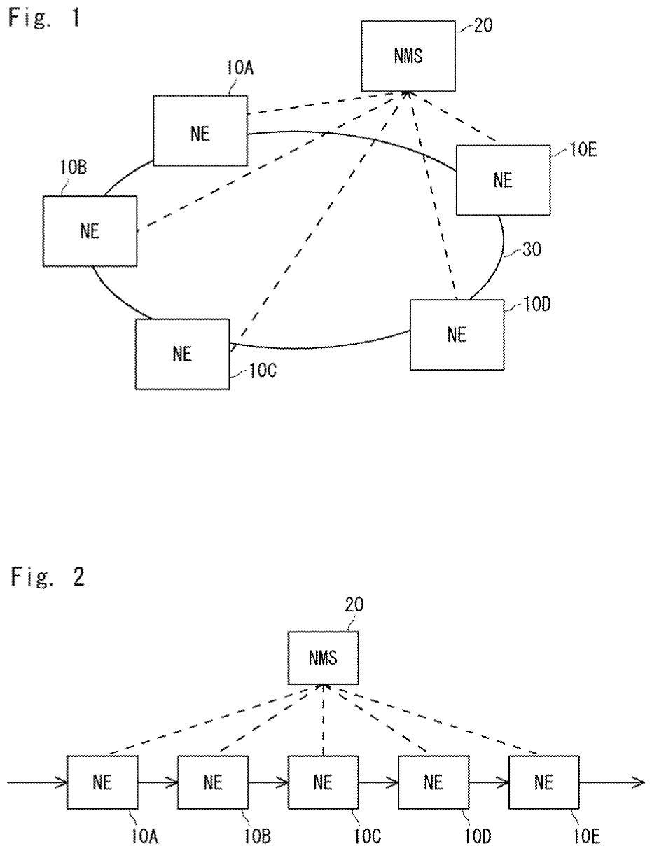

As shown in FIG. 1, the WDM transmission system according to this example embodiment includes a plurality of NEs (Node Equipment: node apparatuses) 10A-10E and a Network Management System (NMS) 20. In the following, the NEs 10A-10E are simply referred to as an NE 10 when it is not necessary to differentiate among them. The plurality of NEs 10 are connected to one another via an optical fiber 30. While FIG. 1 shows five NEs 10, the number of NEs 10 is not limited to five. Further, while FIG. 1 shows an example in which the number of paths of each of the NEs 10 is two, the number of paths of each of the NEs 10 is not limited to two. Further, while FIG. 1 shows a ring-type network, the network topology is not limited to a ring type and may be, for example, a line-type network, as shown in, FIG. 2.

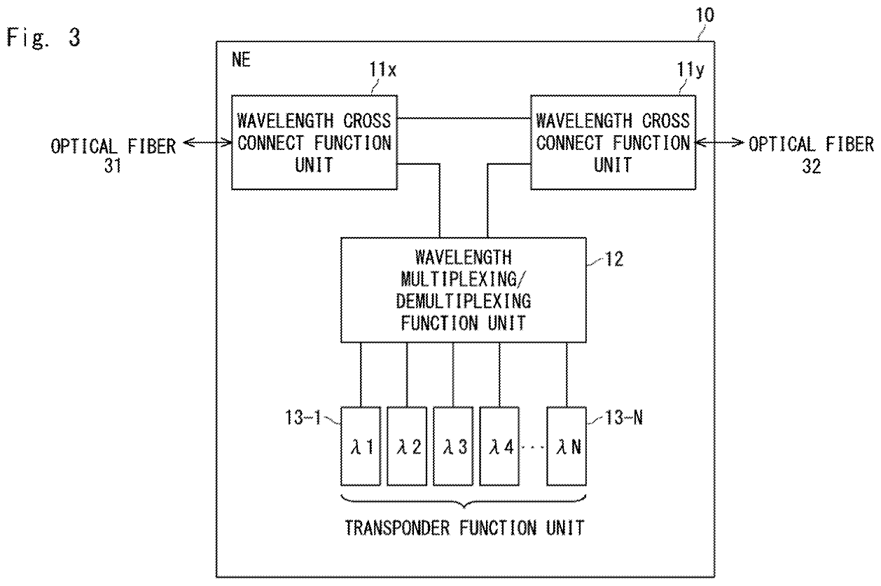

Referring next to FIG. 3, a configuration example of a functional block according to optical signal processing of the NE 10 according to this example embodiment will be described. FIG. 3 shows a configuration example of the NE 10 having two paths.

As shown in FIG. 3, the NE 10 according to this example embodiment includes wavelength cross connect function units 11x and 11y, a wavelength multiplexing/demultiplexing function unit 12, and transponder function units 13-1-13-N. Hereinafter, the wavelength cross connect function units 11x and 11y are simply referred to as a wavelength cross connect function unit 11 when it is not necessary to differentiate between them. Further, the transponder function units 13-1-13-N are simply referred to as a transponder function unit 13 when it is not necessary to differentiate among them.

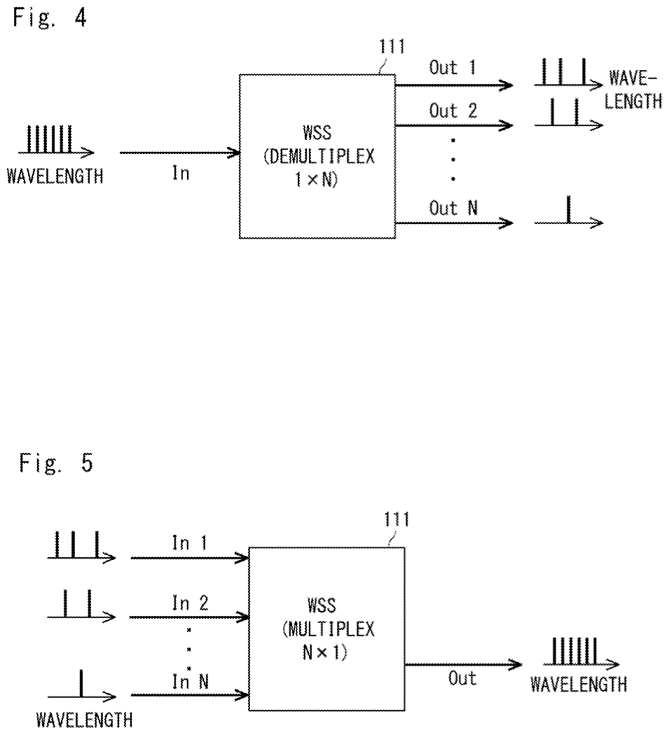

The wavelength cross connect function unit 11x includes a WSS 111x that will be described later. Further, the wavelength cross connect function unit 11y includes a WSS 111y that will be described later. In the following, the WSSs 111x and 111y are simply referred to as a WSS 111 when it is not necessary to differentiate between them. The WSS 111 includes a function of wavelength-demultiplexing a wavelength-multiplexed optical signal that passes through the WSS 111 into optical signals having respective wavelengths, as shown in FIG. 4. Further, the WSS 111 includes a function of wavelength-multiplexing optical signals having respective wavelengths that pass through the WSS 111, as shown in FIG. 5.

Further, in FIG. 3, the WSS 111x includes a function of wavelength-demultiplexing an optical signal input from an optical fiber 31 and outputting an optical signal of the selected wavelength to the wavelength multiplexing/demultiplexing function unit 12 (DROP). At this time, optical signals of the remaining wavelengths are wavelength-multiplexed by the wavelength cross connect function unit 11y and the wavelength-multiplexed signal is output to an optical fiber 32. The WSS 111x further includes a function of wavelength-multiplexing optical signals input from the wavelength multiplexing/demultiplexing function unit 12 into an optical signal input from the wavelength cross connect function unit 11y and outputting the wavelength-multiplexed signal to the optical fiber 31 (ADD). The WSS 111x further includes a function of directly outputting wavelength-demultiplexed optical signals to the wavelength cross connect function unit 11y (THRU) without dropping the wavelength-demultiplexed optical signals.

Further, in FIG. 3, the WSS 111y includes a function of wavelength-demultiplexing the optical signal input from the optical fiber 32 and outputting the optical signal of the selected wavelength to the wavelength multiplexing/demultiplexing function unit 12 (DROP). At this time, optical signals of the remaining wavelengths are wavelength-multiplexed by the wavelength cross connect function unit 11x and the wavelength-multiplexed signal is output to the optical fiber 31. Further, the WSS 111y includes a function of wavelength-multiplexing the optical signals input from the wavelength multiplexing/demultiplexing function unit 12 into an optical signal input from the wavelength cross connect function unit 11x and outputting the wavelength-multiplexed signal to the optical fiber 32 (ADD). The WSS lily further includes a function of directly outputting the wavelength-demultiplexed optical signals to the wavelength cross connect function unit 11x (THRU) without dropping the wavelength-demultiplexed optical signals.

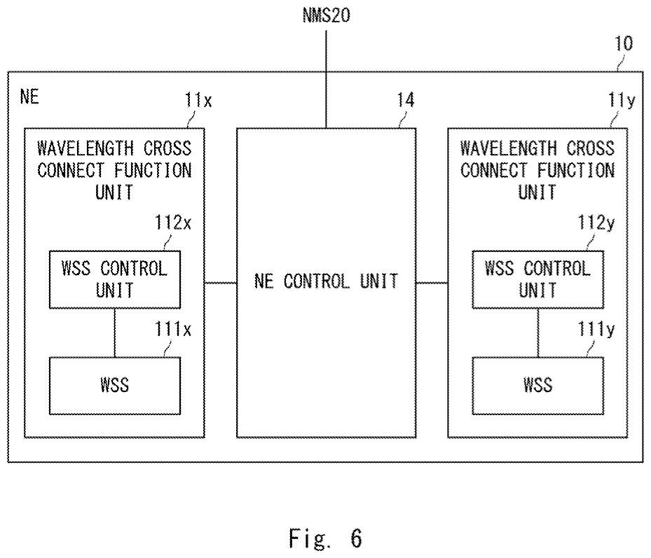

Referring next to FIG. 6, a configuration example of a function block according to control by the NE 10 according to this example embodiment will be described. FIG. 6 shows a configuration example of the NE 10 having two paths.

As shown in FIG. 6, the NE 10 according to this example embodiment further includes an NE control unit 14. Further, the wavelength cross connect function unit 11x includes, besides the aforementioned WSS 111x, a WSS control unit 112x. Further, the wavelength cross connect function unit 11y includes, besides the aforementioned WSS 111y, a WSS control unit 112y. In the following, the USS control units 112x and 112y will be referred to as a WSS control unit 112 when it is not necessary to differentiate between them.

When an optical path (a route of an optical signal) is set, cross-connect route setting information for setting the route of the optical signal is transmitted from the NMS 20 to each of the NEs 10A-10E.

In each of the NEs 10A-10E, the NE control unit 14 receives the route setting information from the NMS 20 and passes the received route setting information to each of the wavelength cross connect function units 11x and 11y.

In each of the wavelength cross connect function units 11x and 11y, the WSS control unit 112 allocates a necessary configuration to the WSS 111 based on the route setting information.

Hereinafter, an operation of the WDM transmission system according to this example embodiment will be described.

First, the premise of the operation of the WDM transmission system according to this example embodiment will be described.

The WSS 111 allows, in accordance with configurations allocated to the plurality of respective slots that correspond to the plurality of channels, optical signals of the plurality of respective slots to pass.

The WSS control unit 112 determines whether each of the plurality of slots is used or unused based on the route setting information from the NMS 20. Further, the WSS control unit 112 allocates, based on the route setting information, a configuration to one of the plurality of slots which is to be used. The configurations to be allocated to the slot to be used are, for example, a pass and processing when an optical signal is made to pass through the path (DROP, ADD, or THRU).

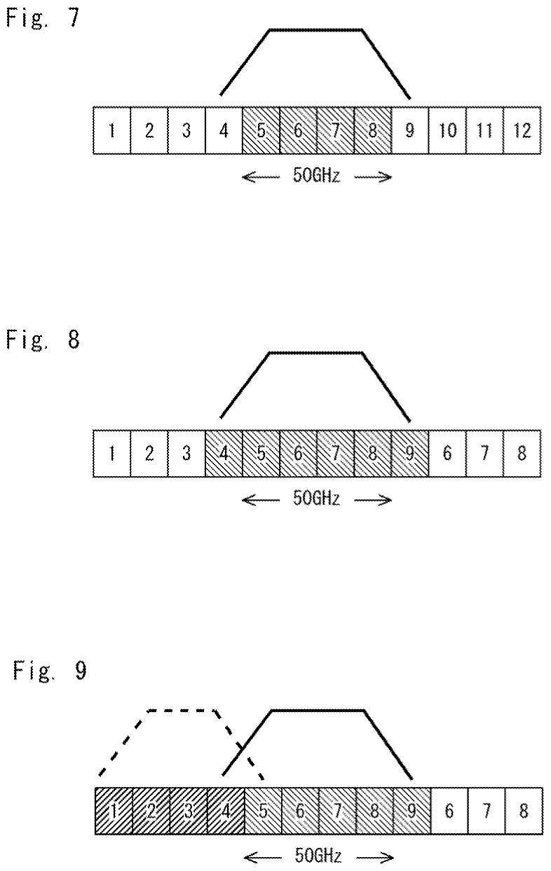

FIG. 7 shows an example of the state of the configuration of slots when optical signals pass through the WSS 111. Note that FIG. 7 is an example in which the wavelength band is 50 GHz. In the example shown in FIG. 7, one slot has 12.5 GHz and four slots are used as the wavelength band. As described above, when the wavelength band is set to 50 GHz, optical signals of 80 slots (channels) may be, for example, made to pass. FIG. 7 shows only 12 slots of slots 1-12 among them.

In the example shown in FIG. 7, slots 5-8 are used. A configuration for causing optical signals to pass through one path is allocated, for example, to the slots 5-8. On the other hand, the other slots 1-4 and 9-12 are unused.

When a desired slot is focused on in FIG. 7, states of the configuration of an adjacent slot that is adjacent to the desired slot when an optical signal passes through the WSS 111 are classified into the following three patterns.

(A) unused
(B) configured to a path the same as the desired slot
(C) configured to a path other than the desired slot

Of the above patterns, the wavelength band becomes narrow when the adjacent slot is in the state of the configuration as shown in the above (A) and (C). On the other hand, when the adjacent slot is in the state of the configuration as shown in the above (B), the wavelength band does not become narrow.

Further, the WDM transmission system is often operated as follows.

(a) Not all the slots are used from the beginning. Instead, the number of slots to be used is gradually increased (that is, there are also unused slots in the beginning).
(b) In the actual network, if the optical signal of the desired slot passes through the WSS 111, the state of the configuration of an adjacent slot that is adjacent to the desired slot is often configured as being unused or configured to cause an optical signal to pass through a path the same as the slot.

When the operation method of the WDM transmission system described above is taken into account, it may be considered that the transmission characteristics will be improved by preventing the wavelength band in the case in which the state of the configuration in the adjacent slot is unused from occurring.

In order to achieve the above object, in this example embodiment, when an adjacent slot that is adjacent to a desired slot is unused, the WSS control unit 112 additionally allocates a configuration for allowing an optical signal to pass through a path the same as that of the desired slot to the adjacent slot. At this time, the WSS control unit 112 may additionally allocate, in accordance with the operation of the WDM transmission system stated in the above (b), a configuration for causing an optical signal to pass through a path the same as that of the desired slot to the adjacent slot.

In the example shown in FIG. 7, for example, when the slot 5 is focused on, the slot 4 that is adjacent to the slot 5 is unused. Further, when the slot 8 is focused on, the slot 9 that is adjacent to the slot 8 is unused.

However, in the related art, no special measure is taken for the slots 4 and 9. Therefore, if no measure is taken, the wavelength band becomes narrow in the slots 5 and 8.

In order to solve the above problem, in this example embodiment, as shown in FIG. 8, the WSS control unit 112 additionally allocates a configuration for causing the optical signal to pass through a path the same as the slot 5 to the slot 4 and additionally allocates a configuration for causing the optical signal to pass through a path that is the same as the slot 8 to the slot 9.

Accordingly, the state of the configuration of the slot 4 that is adjacent to the slot 5 is a configuration for causing an optical signal to pass through a path the same as the slot 5 (i.e., the configuration in the above (B)). Further, the state of the configuration of the slot 9 that is adjacent to the slot 8 is a configuration for causing an optical signal to pass through a path the same as the slot 8 (i.e., the configuration in the above (B)). As a result, in the slots 5 and 8, the wavelength band does not become narrow.

Note that, according to the operation method in the above (a), the WDM transmission system performs an operation in such a way that the number of slots to be used is gradually increased. Therefore, slots that are unused at first may be used later.

In this example embodiment, the WSS control unit 112 cancels, if the adjacent slot that has not been used is to be used, the configuration additionally allocated to the adjacent slot.

It is assumed, as shown in FIG. 9, that the slot 4 that has not been used is to be used. In this case, in this example embodiment, the WSS control unit 112 cancels the configuration that has been additionally allocated to the slot 4. On the other hand, the slot 9 is still unused. Therefore, the WSS control unit 112 leaves a configuration that has been additionally allocated to the slot 9 as it is.

While FIG. 9 assumes that a configuration for causing optical signals to pass through a path other than the path through which optical signals pass in the slot 5 is newly allocated to the slot 4, this is merely an example. Even when a configuration for causing optical signals to pass through a path the same as the path through which optical signals pass in the slot 5 is newly allocated to the slot 4, the WSS control unit 112 cancels the configuration that has been additionally allocated to the slot 4.

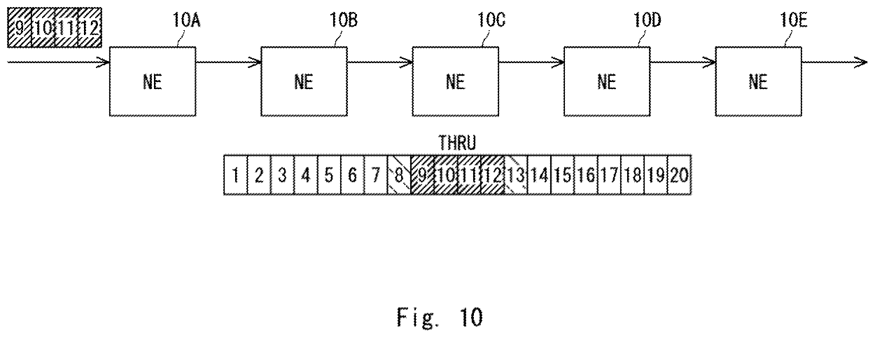

Hereinafter, with reference to FIGS. 10-12, effects of the WDM transmission system according to the example embodiment will be described.

FIG. 10 is an example in which the NEs 10A-10E cause the optical signals of the slots 9-12 to pass therethrough. Further, the slots in FIG. 10 show an example of the state of the configuration of the slots when the optical signals pass through the WSS 111 of the NE 10C.

In the example shown in FIG. 10, slots 9-12 are the slots used when optical signals pass through the WSS 111 of the NE 10C. Further, slots 8 and 13 are unused slots among the adjacent slots that are adjacent to the slots 9-12 to be used. Therefore, in the NE 10C, a configuration for causing the optical signals to pass through the paths that are the same as the slots 9-12 is additionally allocated to the slots 8 and 13. Therefore, in the NE 10C, the wavelength band does not become narrow.

Further, the other NEs 10A, 10B, 10D, and 10E also cause the optical signals of the slots 9-12 to pass therethrough, like the NE 10C. Therefore, the state of the configuration of the slots when the optical signals pass through the WSS 111 of the NEs 10A, 10B, 10D, and 10E is similar to that in FIG. 10. Therefore, the wavelength band does not become narrow in the NEs 10A, 10B, 10D, and 10E as well.

Accordingly, in the example shown in FIG. 10, in any one of the NEs 10A-10E, the wavelength band does not become narrow, whereby it is possible to improve transmission characteristics.

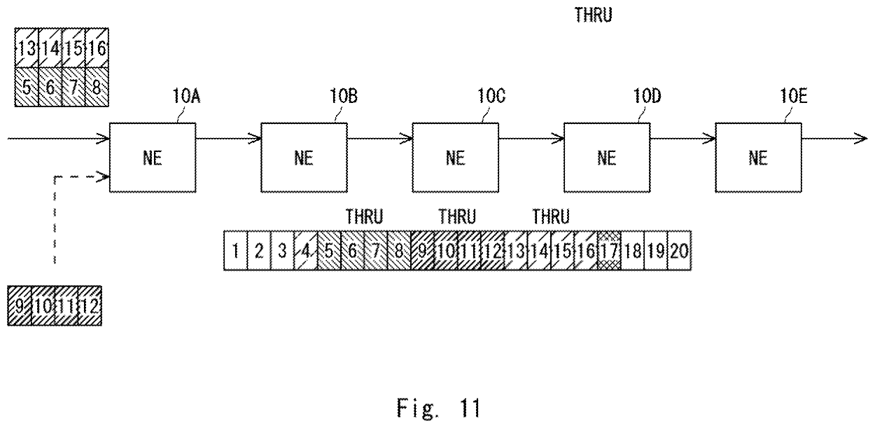

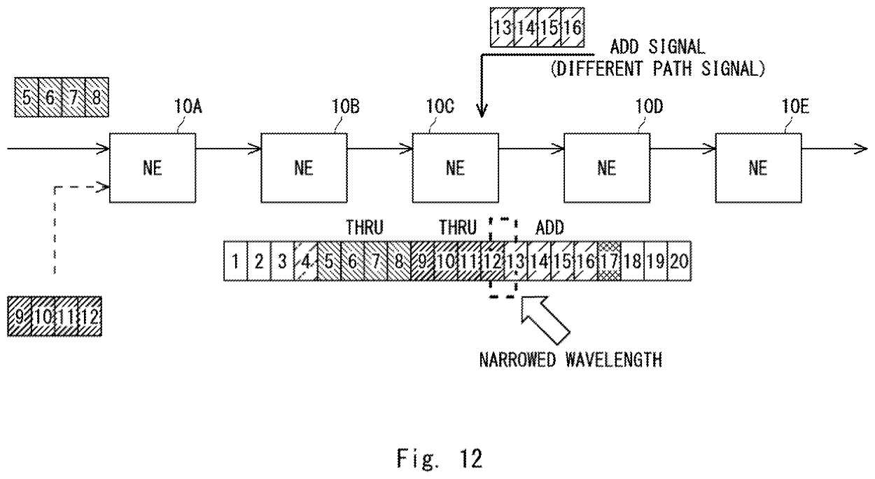

FIG. 11 is an example in which the NE 10A adds optical signals of the slots 9-12, which are the same paths as the slots 5-8 and 13-16 to the optical signals of the slots 5-8 and 13-16, and the NEs 10B-10E cause the optical signals of the slots 5-16 to pass therethrough. Further, the slots shown in FIG. 11 show an example of the state of the configuration of the slots when optical signals pass through the WSS 111 of the NE 10C.

In the example shown in FIG. 11, the slots 5-16 are the slots to be used when optical signals pass through the WSS 111 of the NE 10C. Further, the slots 4 and 17 are unused slots among adjacent slots that are adjacent to the slots 5-16 that are to be used. Therefore, in the NE 10C, a configuration for allowing the optical signals to pass through the paths the same as the slots 5-16 is additionally allocated to the slots 4 and 17. Therefore, the wavelength band does not become narrow in the NE 10C.

Further, the other NEs 10B, 10D, and 10E also allow the optical signals of the slots 5-16 to pass therethrough, like the NE 10C. Therefore, the state of the configuration of the slots when optical signals pass through the WSS 111 of the NEs 10B, 10D, and 10E is similar to that shown in FIG. 11. Therefore, in the NEs 10B, 10D, and 10E as well, the wavelength band does not become narrow.

Further, while the NE 10A adds optical signals of the slots 9-12 to the optical signals of the slots 5-8 and 13-16, the path of the slots 5-8 and 13-16 is the same as the path of the slots 9-12. Further, in the NE 10A as well, a configuration for causing optical signals to pass through the paths that are the same as the slots 9-12 is additionally allocated to the unused adjacent slots 4 and 17, although it is not shown in the drawing. Therefore, in the NE 10A as well, the wavelength band does not become narrow.

Accordingly, in the example shown in FIG. 11, in any one of the NEs 10A-10E, the wavelength band does not become narrow, whereby it is possible to improve transmission characteristics.

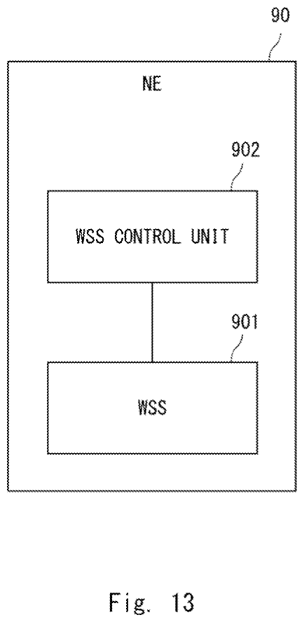

FIG. 12 shows an example in which the NE 10A adds optical signals of the slots 9-12 the same paths as the slots 5-8 to the optical signals of the slots 5-8, the NE 10B causes the optical signals of the slots 5-12 to pass therethrough, the NE 10C adds optical signals of the slots 13-16, which are paths different from the slots 5-12, to the optical signals of the slots 5-12, and the NEs 10D and 10E cause the optical signals of the slots 5-16 to pass therethrough. Further, the slots in FIG. 12 show an example of the state of the configuration of the slots when optical signals pass through the WSS 111 of the NE 10C.

In the example shown in FIG. 12, the slots 5-16 are the slots to be used when optical signals pass through the WSS 111 of the NE 10C. Further, the slots 4 and 17 are unused slots among adjacent slots that are adjacent to the slots 5-16 that are to be used. Therefore, in the NE 10C, a configuration for allowing the optical signal to pass through a path the same as the slot 5 is additionally allocated to the slot 4 and a configuration for allowing the optical signal to pass through a path that is the same as the slot 16 is additionally allocated to the slot 17. Therefore, in the slots 5 and 16, the wavelength band does not become narrow. However, the NE 10C adds optical signals of the slots 13-16, which are paths different from the slots 5-12, to the optical signals of the slots 5-12. Therefore, the adjacent slots 12 and 13 are paths different from each other. As a result, in the slots 12 and 13, the wavelength band becomes narrow.

On the other hand, the operations of the other NEs 10A, 10B, 10D, and 10E are substantially similar to the NEs 10A, 10B, 10D, and 10E shown in FIG. 11. Therefore, in the NEs 10A, 10B, 10D, and 10E, the wavelength band does not become narrow.

Accordingly, in the example shown in FIG. 12, the wavelength band does not become narrow in the NEs 10A, 10B, 10D, and 10E, whereas the wavelength band becomes narrow in the NE 10C. However, with regard to the whole WDM transmission system, the wavelength band is narrow only in the NE 10C, which means that it is possible to sufficiently prevent the wavelength band from being narrow. Therefore, it is possible to improve transmission characteristics.

As described above, according to this example embodiment, the WSS control unit 112 additionally allocates, if an adjacent slot that is adjacent to a desired slot is unused, a configuration for allowing an optical signal to pass through a path the same as that of the desired slot to the adjacent slot. Accordingly, the wavelength band does not become narrow in the desired slot.

As a result, it is possible to prevent the wavelength band from becoming narrow in the whole WDM transmission system, whereby it is possible to improve transmission characteristics.

Further, since the transmission characteristics of the WDM transmission system are improved, it becomes possible to further make the wavelength band narrow and to employ a small-sized WSS. Accordingly, it becomes possible to meet a demand for improvement of the utilization efficiency of a wavelength band and for reduction in the size of the NE 10.

### Concept of Example Embodiment

Referring next to FIG. 13, a configuration example of an NE 90 that conceptually shows the NE 10 according to the aforementioned example embodiment will be described.

As shown in FIG. 13, the NE 90 includes a WSS 901 and a WSS control unit 902. The WSS 901 corresponds to the WSS 111 according to the aforementioned example embodiment and the WSS control unit 902 corresponds to the WSS control unit 112 according to the aforementioned example embodiment.

The WSS 901 allows, in accordance with configurations allocated to a plurality of respective slots, optical signals of the plurality of respective slots to pass.

The WSS control unit 902 allocates configurations to the plurality of respective slots. The WSS control unit 902 additionally allocates, if an adjacent slot adjacent to a desired one of the plurality of slots is unused, a configuration for allowing an optical signal to pass through a path the same as that of the desired slot to the adjacent slot. At this time, the WSS control unit 902 may additionally allocate a configuration for causing optical signals to pass through a path the same as that of the desired slot to the adjacent slot.

Further, the WSS control unit 902 may cancel, if the adjacent slot is used, the configuration additionally allocated to the adjacent slot.

Further, the WSS control unit 902 may determine whether each of the plurality of slots is used or unused based on the route setting information transmitted from the NMS (e.g., the NMS 20 according to the aforementioned example embodiment). Then, the WSS control unit 902 may allocate the configuration based on route setting information to one of the plurality of slots which is to be used.

While the present disclosure has been described above with reference to the example embodiment, the present disclosure is not limited to the aforementioned example embodiment. Various changes that may be understood by one skilled in the art may be made to the configurations and the details of the present disclosure within the scope of the present disclosure.

For example, the present disclosure can implement desired processing of the NEs 10 and 90 by a processor such as a Central Processing Unit (CPU) loading a computer program stored in a memory and executing the loaded computer program.

In the aforementioned examples, the program(s) can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto-optical disks), Compact Disc-Read Only Memory (CD-ROM), CD-Recordable (CD-R), CD-ReWritable (CD-R/W), semiconductor memories (such as mask ROM, Programmable ROM (PROM), Erasable PROM (EPROM), flash ROM, Random Access Memory (RAM), etc.). Further, the program(s) may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

The whole or part of the example embodiments disclosed above can be described as, but not limited to, the following supplementary notes.

(Supplementary Note 1)

A node apparatus in a Wavelength Division Multiplexing (WDM) transmission system, the node apparatus comprising:

a wavelength selective switch configured to allow, in accordance with configurations allocated to a plurality of respective slots, optical signals of the plurality of respective slots to pass; and

a control unit configured to allocate the configurations to the plurality of slots,

wherein the control unit additionally allocates, if an adjacent slot adjacent to a desired one of the plurality of slots is unused, the configuration for allowing an optical signal to pass through a path the same as that of the desired slot to the adjacent slot.

(Supplementary Note 2)

The node apparatus according to Supplementary Note 1, wherein the control unit additionally allocates, if the adjacent slot is unused, the configuration for allowing an optical signal to pass through a path the same as that of the desired slot to the adjacent slot.

(Supplementary Note 3)

The node apparatus according to Supplementary Note 1 or 2, wherein the control unit cancels, if the adjacent slot is used, the configuration additionally allocated to the adjacent slot.

(Supplementary Note 4)

The node apparatus according to any one of Supplementary Notes 1 to 3, wherein the control unit determines whether each of the plurality of slots is used or unused based on route setting information for setting the route of an optical signal, the route setting information being transmitted from a Network Management System (NMS).

(Supplementary Note 5)

The node apparatus according to Supplementary Note 4, wherein the control unit allocates, based on the route setting information, the configuration to one of the plurality of slots which is to be used.

(Supplementary Note 6)

A Wavelength Division Multiplexing (WDM) transmission system comprising:

a plurality of node apparatuses connected to each other, wherein

each of the plurality of node apparatuses comprises:
a wavelength selective switch configured to allow, in accordance with configurations allocated to a plurality of respective slots, optical signals of the plurality of respective slots to pass; and
a control unit configured to allocate the configurations to the plurality of slots, and

the control unit additionally allocates, if an adjacent slot adjacent to a desired one of the plurality of slots is unused, the configuration for allowing an optical signal to pass through a path the same as that of the desired slot to the adjacent slot.

(Supplementary Note 7)

The WDM transmission system according to Supplementary Note 6, wherein the control unit additionally allocates, if the adjacent slot is unused, the configuration for allowing an optical signal to pass through a path the same as that of the desired slot to the adjacent slot.

(Supplementary Note 8)

The WDM transmission system according to Supplementary Note 6 or 7, wherein the control unit cancels, if the adjacent slot is used, the configuration additionally allocated to the adjacent slot.

(Supplementary Note 9)

The WDM transmission system according to any one of Supplementary Notes 6 to 8, further comprising a Network Management System (NMS) configured to transmit, to each of the plurality of node apparatuses, route setting information for setting the route of an optical signal,

wherein the control unit determines, based on the route setting information, whether each of the plurality of slots is used or unused.

(Supplementary Note 10)

The WDM transmission system according to Supplementary Note 9, wherein the control unit allocates, based on the route setting information, the configuration to one of the plurality of slots which is to be used.

(Supplementary Note 11)

A control method of a wavelength selective switch in a Wavelength Division Multiplexing (WDM) transmission system, wherein

the wavelength selective switch allows, in accordance with configurations allocated to a plurality of respective slots, optical signals of the plurality of respective slots to pass,

the control method includes a control step for allocating the configurations to the plurality of slots, and

in the control step, if an adjacent slot adjacent to a desired one of the plurality of slots is unused, the configuration for allowing an optical signal to pass through a path the same as that of the desired slot is additionally allocated to the adjacent slot.

This application is based upon and claims the benefit of priority from Japanese Patent Application No. 2020-056640, filed on Mar. 26, 2020, the disclosure of which is incorporated herein in its entirety by reference.

### REFERENCE SIGNS LIST

10, 10A-10E, 90 NE
11x, 11y m Wavelength Cross Connect Function Unit
111, 111x, 111y, 901 WSS
112x, 112y, 902WSS Control Unit
12 Wavelength Multiplexing/demultiplexing Function Unit
13-1-13-N Transponder Function Unit
14 NE Control Unit
20 NMS

What is claimed is:

1. A node apparatus in a Wavelength Division Multiplexing (WDM) transmission system, the node apparatus comprising:
a wavelength selective switch configured to allow, in accordance with configurations allocated to a plurality of respective slots, optical signals of the plurality of respective slots to pass; and
a control unit configured to allocate the configurations to the plurality of slots,
wherein the control unit additionally allocates, if an adjacent slot adjacent to a desired one of the plurality of slots is unused, the configuration for allowing an optical signal to pass through a path the same as that of the desired slot to the adjacent slot.

2. The node apparatus according to claim 1, wherein the control unit additionally allocates, if the adjacent slot is unused, the configuration for allowing an optical signal to pass through a path the same as that of the desired slot to the adjacent slot.

3. The node apparatus according to claim 1, wherein the control unit cancels, if the adjacent slot is used, the configuration additionally allocated to the adjacent slot.

4. The node apparatus according to claim 1, wherein the control unit determines whether each of the plurality of slots is used or unused based on route setting information for setting the route of an optical signal, the route setting information being transmitted from a Network Management System (NMS).

5. The node apparatus according to claim 4, wherein the control unit allocates, based on the route setting information, the configuration to one of the plurality of slots which is to be used.

6. A Wavelength Division Multiplexing (WDM) transmission system comprising:
a plurality of node apparatuses connected to each other, wherein
each of the plurality of node apparatuses comprises:
a wavelength selective switch configured to allow, in accordance with configurations allocated to a plurality of respective slots, optical signals of the plurality of respective slots to pass; and
a control unit configured to allocate the configurations to the plurality of slots, and
the control unit additionally allocates, if an adjacent slot adjacent to a desired one of the plurality of slots is unused, the configuration for allowing an optical signal to pass through a path the same as that of the desired slot to the adjacent slot.

7. The WDM transmission system according to claim 6, wherein the control unit additionally allocates, if the adjacent slot is unused, the configuration for allowing an optical signal to pass through a path the same as that of the desired slot to the adjacent slot.

8. The WDM transmission system according to claim 6, wherein the control unit cancels, if the adjacent slot is used, the configuration additionally allocated to the adjacent slot.

9. The WDM transmission system according to claim 6, further comprising a Network Management System (NMS) configured to transmit, to each of the plurality of node apparatuses, route setting information for setting the route of an optical signal,
wherein the control unit determines, based on the route setting information, whether each of the plurality of slots is used or unused.

10. The WDM transmission system according to claim 9, wherein the control unit allocates, based on the route setting information, the configuration to one of the plurality of slots which is to be used.

11. A control method of a wavelength selective switch in a Wavelength Division Multiplexing (WDM) transmission system, wherein
the wavelength selective switch allows, in accordance with configurations allocated to a plurality of respective slots, optical signals of the plurality of respective slots to pass,
the control method includes a control step for allocating the configurations to the plurality of slots, and
in the control step, if an adjacent slot adjacent to a desired one of the plurality of slots is unused, the configuration for allowing an optical signal to pass through a path the same as that of the desired slot is additionally allocated to the adjacent slot.
